(19) United States
(12) Patent Application Publication
(10) Pub. No.: US 2017/0267805 A1
(43) Pub. Date: Sep. 21, 2017

(54) AUTOMOTIVE INTERIOR MATERIAL AND METHOD FOR MANUFACTURING THE SAME

(71) Applicant: TOYOTA JIDOSHA KABUSHIKI KAISHA, Toyota-shi (JP)

(72) Inventors: Takahiro HATANAKA, Fukui-shi (JP); Kaoru SASAKI, Fukui-shi (JP); Madoka ABE, Nagoya-shi (JP); Kei TASHIRO, Toyota-shi (JP); Atsunori ADACHI, Miyoshi-shi (JP)

(73) Assignee: TOYOTA JIDOSHA KABUSHIKI KAISHA, Toyota-shi (JP)

(21) Appl. No.: 15/451,649

(22) Filed: Mar. 7, 2017

(30) Foreign Application Priority Data
Mar. 18, 2016 (JP) 2016-056009

(51) Int. Cl. C08G 18/44; C08G 18/32; C08G 18/66; D04H 1/488; C08G 18/22; C09D 175/04; D04H 1/435; C08G 18/34; C08G 18/75

(52) U.S. Cl. CPC C08G 18/44; C08G 18/348; C08G 18/3206; C08G 18/6659; C08G 18/758; C08G 18/227; C09D 175/04; D04H 1/435; D04H 1/488

(57) ABSTRACT

An automotive interior material comprises: a polyester needle-punched nonwoven fabric; and a polycarbonate-based polyurethane resin attached to the polyester needle-punched nonwoven fabric, wherein
the polycarbonate-based polyurethane resin is obtained by reacting an organic polyisocyanate with a polyol comprising 30 to 99% by mass of a polycarbonate diol represented by the following general formula (1):

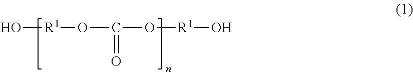

wherein R¹s each independently represent an alkylene group having 4 to 8 carbon atoms, and n represents an integer with which a molecular weight of the compound represented by the formula (1) is in a range from 1000 to 3500,
with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals, and dispersing the urethane prepolymer in water by emulsification, followed by chain extension with a polyamine having two or more amino groups of at least one type selected from a primary amino group and a secondary amino group, and
the amount of the polycarbonate-based polyurethane resin attached is 1 to 15 parts by mass relative to 100 parts by mass of the polyester needle-punched nonwoven fabric.

### BACKGROUND OF THE INVENTION

Field of the Invention

The present invention relates to an automotive interior material and a method for manufacturing the same.

Related Background Art

Many fiber products have been used for the interior of automobiles. Woven fabrics and knitted fabrics made of polyester filaments and having good wear resistance have mainly been used as materials for portions, such as car seats and door trims, where wearing is highly likely to occur because of getting-on and -off of drivers and passengers and direct contact with their hands. On the other hand, needle-punched nonwoven fabrics using regenerated polyester staple fibers as a raw material have been mainly used as materials for portions, such as the ceiling, where wearing is less likely to occur and portions, such as carpets and luggage areas, which are ordinarily out of sight and where the damage due to wearing, if any, does not attract people's attention.

Needle-punched nonwoven fabric is a nonwoven fabric obtained as follows. Specifically, a sheet called web, in which fibers are stacked on one another, is formed from staple fibers of polyester or the like by using a carding machine or the like. Then, the web is punched with needles having protrusions called barbs of a needle loom to mechanically entangle the fibers with one another. For this reason, needle-punched nonwoven fabric is, for example, advantageous in that it is less expensive than woven fabrics and knitted fabrics made of polyester filaments, it has a felt-like soft surface texture, and it can be formed into any shape (good processability) because of its stretchability. However, needle-punched nonwoven fabric is poor in wear resistance, and hence has such a problem that when the needle-punched nonwoven fabric is used for a wear-susceptible portion in an automobile, the wearing causes deterioration in surface texture and design.

The following are examples of automotive interior materials using nonwoven fabrics. Japanese Unexamined Patent Application Publication No. Hei 8-13305 (Patent Document 1) describes an automobile interior surface material obtained by a method in which a web is subjected to needle punch, and further to stitch bonding, and then a thermoplastic resin is attached thereto, or a method in which a web mixed with binder fibers is subjected to needle punch and further to stitch bonding. Moreover, Japanese Unexamined Patent Application Publication No. Hei 3-189250 (Patent Document 2) describes an automobile interior surface material in which a spunbonded nonwoven fabric made of a polyester-based resin and a polyolefin resin is integrally stacked on a back surface of a needle punched entangled nonwoven fabric.

In addition, Japanese Utility Model Registration Application Publication No. Hei 4-127291 (Patent Document 3) describes a nonwoven fabric interior material in which fibers are fusion bonded to each other by needle punching and then heating a fiber layer (web), which has been formed by mixing composite fibers with regular polyester fibers. Moreover, Japanese Examined Utility Model Registration Application Publication No. Hei 5-46522 (Patent Document 4) describes an automotive interior material in which a foamed latex layer is stacked on and impregnated into one surface of a nonwoven fabric, and describes a polyester needle-punched nonwoven fabric as the nonwoven fabric and polyurethane and an acrylic resin as the latex.

Moreover, Japanese Unexamined Patent Application Publication No. Hei 10-120757 (Patent Document 5) describes a polycarbonate-based polyurethane resin composition, and recites that the polycarbonate-based polyurethane resin composition can be used for treatment on various fiber materials.

However, no automotive interior material has been disclosed yet which has an excellent wear resistance, while retaining the texture and good processability of needle-punched nonwoven fabric.

### SUMMARY OF THE INVENTION

The present invention has been made in view of the above-described problems of the conventional techniques, and an object of the present invention is to provide an automotive interior material which has an excellent wear resistance, while retaining the texture and good processability of needle-punched nonwoven fabric, as well as a method for manufacturing the same.

The present inventors have conducted intensive study to achieve the above-described object, and consequently have found that attaching a specific supported amount of a specific polycarbonate-based polyurethane resin to a polyester needle-punched nonwoven fabric makes it possible to sufficiently improve the wear resistance, while retaining the texture and good processability of the needle-punched nonwoven fabric. This finding has led to the completion of the present invention.

Specifically, an automotive interior material of the present invention comprises: a polyester needle-punched nonwoven fabric; and a polycarbonate-based polyurethane resin attached to the polyester needle-punched nonwoven fabric, wherein

the polycarbonate-based polyurethane resin is obtained by reacting an organic polyisocyanate with a polyol comprising 30 to 99% by mass of a polycarbonate diol represented by the following general formula (1):

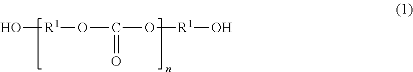

wherein R¹s each independently represent an alkylene group having 4 to 8 carbon atoms, and n represents an integer with which a molecular weight of the compound represented by the formula (1) is in a range from 1000 to 3500,

with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals, and dispersing the urethane prepolymer in water by emulsification, followed by chain extension with a polyamine having two or more amino groups of at least one type selected from a primary amino group and a secondary amino group, and

the amount of the polycarbonate-based polyurethane resin attached is 1 to 15 parts by mass relative to 100 parts by mass of the polyester needle-punched nonwoven fabric.

Meanwhile, a method for manufacturing an automotive interior material of the present invention comprises the steps of:

reacting an organic polyisocyanate with a polyol comprising 30 to 99% by mass of a polycarbonate diol represented by the following general formula (1):

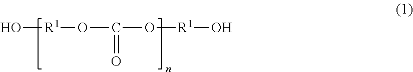

wherein R¹s each independently represent an alkylene group having 4 to 8 carbon atoms, and n represents an integer with which a molecular weight of the compound represented by the formula (1) is in a range from 1000 to 3500,

with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals;

dispersing the urethane prepolymer in water by emulsification, followed by chain extension with a polyamine having two or more amino groups of at least one type selected from a primary amino group and a secondary amino group, to obtain a polycarbonate-based polyurethane resin; and

attaching the polycarbonate-based polyurethane resin to a polyester needle-punched nonwoven fabric, to obtain an automotive interior material comprising the polyester needle-punched nonwoven fabric and the polycarbonate-based polyurethane resin attached to the polyester needle-punched nonwoven fabric, wherein

the amount of the polycarbonate-based polyurethane resin attached is 1 to 15 parts by mass relative to 100 parts by mass of the polyester needle-punched nonwoven fabric.

In the automotive interior material and the method for manufacturing the same of the present invention, n of formula (1) represents an integer with which the molecular weight of the compound represented by the formula (1) is preferably in a range from 1500 to 3300. Further, the polyol comprises preferably 50 to 95% by mass of the polycarbonate diol.

In the automotive interior material and the method for manufacturing the same of the present invention, the amount of the polycarbonate-based polyurethane resin attached is preferably 3 to 12 parts by mass relative to 100 parts by mass of the polyester needle-punched nonwoven fabric.

Note that the claim description related to the automotive interior material of the present invention includes a method for manufacturing a polycarbonate-based polyurethane resin as a part thereof. However, it is extremely difficult to specify the structure or characteristics of the polycarbonate-based polyurethane resin according to the present invention. Specifically, the present inventors speculate that the automotive interior material of the present invention can exhibit the excellent wear resistance, while retaining the texture and good processability of needle-punched nonwoven fabric, because a specific polyisocyanate and a specific polyol are reacted with each other at a specific ratio as described above to obtain a urethane prepolymer, and the urethane prepolymer is subjected to chain extension using a specific polyamine to obtain a polycarbonate-based polyurethane resin, and the polycarbonate-based polyurethane resin is attached in a specific amount to a polyester needle-punched nonwoven fabric. However, since each of the polyisocyanate, the polyol, the urethane prepolymer, and the polyamine has two or more functional groups, it is within the common technical knowledge of those skilled in the art that the structure of the polyurethane resin obtained from these monomers and prepolymer is so complicated that its general formula (structure) is extremely difficult to specify.

According to the present invention, it is possible to provide an automotive interior material which has an excellent wear resistance, while retaining the texture and good processability of needle-punched nonwoven fabric, as well as a method for manufacturing the automotive interior material.

### DETAILED DESCRIPTION OF THE PREFERRED EMBODIMENTS

Hereinafter, the present invention will be described in detail based on preferred embodiments thereof.

An automotive interior material of the present invention comprises: a polyester needle-punched nonwoven fabric; and a polycarbonate-based polyurethane resin attached to the polyester needle-punched nonwoven fabric, wherein

the polycarbonate-based polyurethane resin is obtained by reacting an organic polyisocyanate with a polyol comprising 30 to 99% by mass of a polycarbonate diol represented by the following general formula (1):

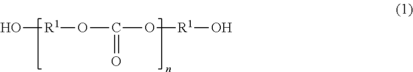

wherein R¹s each independently represent an alkylene group having 4 to 8 carbon atoms, and n represents an integer with which a molecular weight of the compound represented by the formula (1) is in a range from 1000 to 3500,

with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals, and dispersing the urethane prepolymer in water by emulsification, followed by chain extension with a polyamine having two or more amino groups of at least one type selected from a primary amino group and a secondary amino group, and

the amount of the polycarbonate-based polyurethane resin attached is 1 to 15 parts by mass relative to 100 parts by mass of the polyester needle-punched nonwoven fabric.

The polycarbonate-based polyurethane resin according to the present invention is obtained by reacting an organic polyisocyanate with a polyol comprising 30 to 99% by mass of a polycarbonate diol represented by general formula (1), with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals; and dispersing the urethane prepolymer in water by emulsification, followed by chain extension with a polyamine having two or more amino groups of at least one type selected from a primary amino group and a secondary amino group.

The organic polyisocyanate is an organic compound having two or more isocyanate groups (NCO groups). The organic polyisocyanate is not particularly limited, and it is possible to use aliphatic, alicyclic, and aromatic polyisocyanates conventionally and generally used for the synthesis of polyurethane resins. One of these polyisocyanates may be used alone, or two or more thereof may be used in combination.

More specific examples of the organic polyisocyanates include aliphatic diisocyanates such as tetramethylene diisocyanate, hexamethylene diisocyanate, dodecamethylene diisocyanate, trimethylhexamethylene diisocyanate, and lysine diisocyanate; alicyclic diisocyanates such as isophorone diisocyanate, hydrogenated xylylene diisocyanate, 4,4′-dicyclohexylmethane diisocyanate, 3,3′-dimethyl-4,4′-dicyclohexylmethane diisocyanate, and norbornane diisocyanate; and aromatic diisocyanates such as m-phenylene diisocyanate, p-phenylene diisocyanate, 2,4-tolylene diisocyanate, 2,6-tolylene diisocyanate, 4,4′-diphenylmethane diisocyanate, 2,4′-diphenylmethane diisocyanate, 3,3′-dimethyl-4,4′-biphenylene diisocyanate, 3,3′-dichloro-4,4′-biphenylene diisocyanate, 1,5-naphthalene diisocyanate, tolidine diisocyanate, tetramethylenexylylene diisocyanate, and xylylene diisocyanate. Of these organic polyisocyanates, the organic polyisocyanate is preferably at least one selected from the group consisting of hexamethylene diisocyanate, isophorone diisocyanate, and 4,4′-dicyclohexylmethane diisocyanate, from the viewpoint that the wear resistance can be further improved, while sufficiently retaining the surface texture of polyester needle-punched nonwoven fabric, and from the viewpoint of costs.

The polyol is a compound having two or more hydroxy groups (OH groups). In addition, in the present invention, the polyol comprises a polycarbonate diol represented by general formula (1). The polycarbonate diol represented by general formula (1) needs to have a molecular weight (number average molecular weight) of 1000 to 3500. In general formula (1), n represents an integer with which the molecular weight of the polycarbonate diol can be in a range from 1000 to 3500. In addition, the molecular weight of the polycarbonate diol is preferably 1500 to 3300 from the viewpoint that the wear resistance can be further improved, while sufficiently retaining the surface texture of polyester needle-punched nonwoven fabric.

In general formula (1), R¹s each independently represent an alkylene group having 4 to 8 carbon atoms. The alkylene group having 4 to 8 carbon atoms may be linear, branched, or cyclic, and is preferably a linear alkylene group having 4 to 8 carbon atoms from the viewpoint that the wear resistance can be further improved, while sufficiently retaining the surface texture of polyester needle-punched nonwoven fabric.

The polycarbonate diol can be obtained by reacting at least one of dihydroxy compounds represented by the following general formula (2):

HO—R²—OH (2)

wherein R² represents an alkylene group having 4 to 8 carbon atoms, and has the same meaning as that of R¹ in the formula (1),

with a carbonic acid diester. Examples of the carbonic acid diester include dialkyl carbonates such as dimethyl carbonate, diethyl carbonate, and dibutyl carbonate; diaryl carbonates such as diphenyl carbonate; alkylene carbonates such as ethylene carbonate; and the like. One of these carbonic acid diesters may be used alone, or two or more thereof may be used in combination.

In addition, the content of the polycarbonate diol represented by general formula (1) in the polyol needs to be 30 to 99% by mass relative to the total mass of the polyols. If the content of the polycarbonate diol is less than the lower limit, the automotive interior material does not exhibit sufficient texture or wear resistance. In addition, the content of the polycarbonate diol is preferably 50 to 95% by mass relative to the total mass of the polyols, from the viewpoint that the wear resistance can be further improved, while sufficiently retaining the surface texture of polyester needle-punched nonwoven fabric.

Polyols (hereinafter, sometimes referred to as “additional polyols”) other than the polycarbonate diol represented by general formula (1) contained in the polyol include low-molecular weight polyvalent alcohols, polyether-based polyols, polyester-based polyols, and the like.

Examples of the low-molecular weight polyvalent alcohols include ethylene glycol, propylene glycol, 1,4-butanediol, trimethylolpropane, pentaerythritol, sorbitol, dimethylolbutanoic acid, and dimethylolpropionic acid.

Examples of the polyether-based polyols include polyoxyethylene glycols having molecular weights of 400 to 4000, polyoxyethylene polyoxypropylene glycols having molecular weights of 400 to 4000, and polyoxyethylene polyoxytetramethylene glycols having molecular weights of 400 to 4000. Other examples include adducts in which ethylene oxide alone or a combination of ethylene oxide with one or more of other alkylene oxides (propylene oxide, butylene oxide, and the like) is added to the low-molecular weight polyvalent alcohols or low-molecular weight polyalkyleneamines such as ethylenediamine, diethylenetriamine, and triethylenetetramine.

Examples of the polyester-based polyols include polyester-based polyols obtained by dehydration condensation reaction of a diol component such as ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, triethylene glycol, tetraethylene glycol, a polyethylene glycol having a molecular weight of 300 to 1,000, dipropylene glycol, tripropylene glycol, bis(hydroxyethoxy)benzene, 1,4-cyclohexanedimethanol, bisphenol A, bisphenol S, hydrogenated bisphenol A, hydroquinone, or an alkylene oxide adduct thereof with a dicarboxylic acid component such as dimer acid, succinic acid, adipic acid, azelaic acid, sebacic acid, dodecanedicarboxylic acid, maleic anhydride, fumaric acid, 1,3-cyclopentanedicarboxylic acid, terephthalic acid, isophthalic acid, phthalic acid, 1,4-naphthalenedicarboxylic acid, 2,5-naphthalenedicarboxylic acid, 2,6-naphthalenedicarboxylic acid, naphthalic acid, biphenyldicarboxylic acid, 1,2-bisphenoxyethane-p,p′-dicarboxylic acid, or an anhydride or ester-forming derivative of a dicarboxylic acid; polyester-based polyols obtained by ring-opening polymerization reaction of a cyclic ester compound such as ξ-caprolactone; and polyester-based polyols obtained by copolymerization of two or more thereof.

Regarding these polyols, one of the polycarbonate diols may be used alone, or two or more thereof may be used in combination, and one of the additional polyols may be used alone, or two or more thereof may be used in combination.

The urethane prepolymer has isocyanate groups at terminals, and is obtained by reacting the organic polyisocyanate with the polyol (step of obtaining a urethane prepolymer). A method for the reaction is not particularly limited, and it is possible to employ the one-shot method (single step) or the multistep isocyanate polyaddition reaction method, which are conventionally known as methods for synthesizing urethane prepolymers.

A temperature for the reaction is preferably 40 to 150° C. In the reaction, if necessary, it is also possible to add a reaction catalyst such as dibutyltin laurate, stannous octoate, dibutyltin 2-ethylhexoate, triethylamine, triethylenediamine, N-methylmorpholine, or bismuth tris(2-ethylhexanoate); and/or a reaction inhibitor such as phosphoric acid, sodium hydrogen phosphate, p-toluenesulfonic acid, adipic acid, or benzoyl chloride. Moreover, in the reaction, an organic solvent which does not react with an isocyanate group may be further added during the reaction and/or after completion of the reaction. Examples of such an organic solvent include acetone, methyl ethyl ketone, methyl isobutyl ketone, tetrahydrofuran, dioxane, dimethylformamide, dimethyl sulfoxide, toluene, xylene, ethyl acetate, butyl acetate, methylene chloride, and the like. Of these organic solvents, methyl ethyl ketone, toluene, and ethyl acetate are particularly preferable. These organic solvents can be removed by heating under reduced pressure after the dispersing of the urethane prepolymer by emulsification and/or after the chain extension.

In the reaction, the mole ratio between NCO groups of the organic polyisocyanate and OH groups of the polyol (the number of moles of NCO groups/the number of moles of OH groups) needs to be 1.5/1.0 to 1.1/1.0 from the viewpoint of the surface texture and wear resistance of the polyester needle-punched nonwoven fabric.

Moreover, in the reaction, the amount of the organic polyisocyanate blended is preferably 10 to 35% by mass and more preferably 13 to 30% by mass relative to the total mass of the organic polyisocyanate and the polyols, from the viewpoint that the wear resistance can be further improved, while sufficiently retaining the surface texture of polyester needle-punched nonwoven fabric. In addition, from the same viewpoint, the urethane prepolymer preferably has a free isocyanate group content of 0.5 to 3.5% by mass relative to the total mass of the urethane prepolymer.

The polycarbonate-based polyurethane resin according to the present invention is obtained by dispersing the urethane prepolymer in water by emulsification, followed by chain extension with a polyamine (step of obtaining a polycarbonate-based polyurethane resin).

The polyamine is a compound having two or more amino groups of at least one type selected from a primary amino group and a secondary amino group. Examples of the polyamine include ethylenediamine, tetramethylenediamine, hexamethylenediamine, diethylenetriamine, triethylenetetramine, hydrazine, piperazine, diaminodiphenylmethane, tolylenediamine, xylylenediamine, isophoronediamine, and norbornanediamine. One of these polyamines may be used alone, or two or more thereof may be used in combination.

A method for dispersing the urethane prepolymer in water by emulsification and causing the chain extension is preferably, but is not particularly limited to, one in which the urethane prepolymer or a solution containing the urethane prepolymer and the above-described organic solvent is, if necessary, mixed with an emulsifier, and is dispersed in water by emulsification using a homomixer, a homogenizer, or the like, followed by chain extension by adding the polyamine, or one in which the chain extension is carried out by adding the emulsified dispersion obtained by the dispersing by emulsification to a solution containing the polyamine and the above-described organic solvent.

The emulsifier is not particularly limited, and a conventionally known surfactant can be used. Examples of the surfactant include nonionic surfactants such as alkylene oxide adducts of alcohols having 8 to 24 carbon atoms, alkenols having 8 to 24 carbon atoms, polycyclic phenols, amines having 8 to 44 carbon atoms, amides having 8 to 44 carbon atoms, fatty acids having 8 to 24 carbon atoms, polyvalent alcohol fatty acid esters, fats and fatty oils, polypropylene glycol, and the like; anionic surfactants such as anionic derivatives of alcohols, alkenols, various alkylene oxide adducts (the above-described nonionic surfactants and the like); and cationic surfactants such as monoalkyltrimethylammonium salts having 8 to 24 carbon atoms, di alkyldimethylammonium salts having 8 to 24 carbon atoms, monoalkylamine acetic acid salts having 8 to 24 carbon atoms, di alkylamine acetic acid salts having 8 to 24 carbon atoms, and alkylimidazoline quaternary salts having 8 to 24 carbon atoms. One of these surfactants may be used alone, or two or more thereof may be used in combination.

Of these surfactants, it is preferable to use a nonionic surfactant as the emulsifier, from the viewpoint of the miscibility with the other components. Alkylene oxide adducts of polycyclic phenols (polyoxyethylene distyrylphenyl ether-type nonionic surfactants, polyoxyethylene polyoxypropylene distyrylphenyl ether-type nonionic surfactants, polyoxyethylene tristyrylphenyl ether-type nonionic surfactants, polyoxyethylene polyoxypropylene tristyrylphenyl ether-type nonionic surfactants, and the like) and Pluronic-type nonionic surfactants are more preferable. Note that when two or more alkylene oxides are added in the above-described nonionic surfactant, the addition may be random addition or block addition.

To minimize the reaction of the isocyanate groups in the urethane prepolymer with water and/or the emulsifier, the dispersing by emulsification is preferably conducted at a temperature of room temperature to 40° C., and it is more preferable to add a reaction inhibitor, such as phosphoric acid, sodium hydrogen phosphate, p-toluenesulfonic acid, adipic acid, or benzoyl chloride, described above.

Moreover, in the chain extension, that is, in the reaction between the urethane prepolymer and the polyamine, the amount of the polyamine blended is preferably such an amount that amino groups are contained in an amount of 0.8 to 1.2 equivalents to free isocyanate groups of the urethane prepolymer, from the viewpoints of physical properties and yellowing of the automotive interior material. At a temperature of 20 to 50° C., the chain extension usually completes in 30 to 120 minutes after the mixing of the urethane prepolymer with the polyamine.

In addition, if the urethane prepolymer has an ionic group, the ionic group may be neutralized, but does not necessarily have to be neutralized. If the ionic group is neutralized, the ionic group may be neutralized at any stage of obtaining the polycarbonate-based polyurethane resin. When the ionic group is neutralized, the method may be one in which a trialkylamine (trimethylamine, triethylamine, or the like), a trialkanolamine (triethanolamine or the like), ammonia, an alkali metal hydroxide, such as caustic soda or caustic potash, or the like is added as a neutralizing agent.

The polycarbonate-based polyurethane resin according to the present invention is a polyurethane resin obtained by the above-described method, and is a water-dispersible polyurethane resin (polycarbonate-based water-dispersible polyurethane resin). In the present invention, a water-dispersible polyurethane resin refers to a polyurethane resin having self-emulsifiable characteristics (having a capability to disperse by emulsification by itself without addition of any emulsifier). Specifically, the water-dispersible polyurethane resin refers to a polyurethane resin which does not undergo formation of precipitated or suspended matter even in the absence of any emulsifier, when allowed to stand in an aqueous dispersion at a concentration of 35% by mass at room temperature (about 25° C.) for one day.

The automotive interior material of the present invention comprises: a polyester needle-punched nonwoven fabric, and the polycarbonate-based polyurethane resin attached to the polyester needle-punched nonwoven fabric.

The polyester needle-punched nonwoven fabric according to the present invention has a mass per unit area of preferably 50 to 500 g/m², and more preferably 100 to 400 g/m², from the viewpoints that the surface texture is better, and that further excellent wear resistance is exhibited in the automotive interior material. Moreover, the polyester needle-punched nonwoven fabric according to the present invention has a fineness of preferably 0.1 to 100 d, and more preferably 1 to 10 d.

In the automotive interior material of the present invention, the amount of the polycarbonate-based polyurethane resin attached needs to be 1 to 15 parts by mass relative to 100 parts by mass of the polyester needle-punched nonwoven fabric. If the attached amount is less than the lower limit or exceeds the upper limit, a sufficient wear resistance is not exhibited. In addition, from the viewpoint that further excellent wear resistance is exhibited, while sufficiently retaining the surface texture of polyester needle-punched nonwoven fabric, the attached amount is preferably 3 to 12 parts by mass relative to 100 parts by mass of the polyester needle-punched nonwoven fabric.

In addition, the automotive interior material of the present invention is preferably such that the polycarbonate-based polyurethane resin should be sufficiently attached to the inside of the polyester needle-punched nonwoven fabric. The state of the attachment is preferably such that, when cross sections of the automotive interior material are observed at 150 times magnification by using a scanning electron microscope, the attachment of the polycarbonate-based polyurethane resin is observed not only on the surface of the automotive interior material, but also in a portion of the central portion which account for 10% of the thickness of the automotive interior material, and more preferably such that no difference in amount of the polycarbonate-based polyurethane resin attached is found between the central portion and the surface portion of the automotive interior material.

The method (step of obtaining an automotive interior material) for attaching the polycarbonate-based polyurethane resin to a polyester needle-punched nonwoven fabric to obtain the automotive interior material of the present invention as described above is preferably one in which a polyester needle-punched nonwoven fabric is impregnated with a treatment liquid containing the polycarbonate-based polyurethane resin, followed by drying.

A method for the impregnation is not particularly limited, and a conventionally known method can be employed, as appropriate. Examples of the method include an impregnation processing method based on the dip-nip method, a spraying treatment method, a foam processing method, and an impregnation method with coating using a coater.

The treatment liquid is preferably one containing the polycarbonate-based polyurethane resin, water, and, optionally, a water-soluble solvent. The content of the polycarbonate-based polyurethane resin in the treatment liquid is preferably 1 to 95% by mass, and more preferably to 80% by mass. If the content of the polycarbonate-based polyurethane resin is less than the lower limit, it tends to be difficult to attach the resin in an amount necessary for expression of the wear resistance. Meanwhile, if the content of the polycarbonate-based polyurethane resin exceeds the upper limit, it tends to be difficult to uniformly attach the polycarbonate-based polyurethane resin to the polyester needle-punched nonwoven fabric.

A method for the drying is not particularly limited, and, for example, it is possible to employ, as appropriate, air drying, non-humidity drying using heated air; humidity drying using a high-temperature steamer (H. T. S.) or a high-pressure steamer (H. P. S.); microwave irradiation drying, or the like. One of these methods may be used alone, or two or more thereof may be used in combination. The temperature for the drying is preferably 80 to 190° C., and more preferably 110 to 160° C. If the drying temperature is lower than the lower limit, the film formability of the polycarbonate-based polyurethane resin tends to be so poor that sufficient wear resistance cannot be exhibited. Meanwhile, if the drying temperature exceeds the upper limit, the polycarbonate-based polyurethane resin tends to degrade, so that the wear resistance decreases, and the texture deteriorates. In addition, the drying time is preferably 1 to 20 minutes, and more preferably 2 to 10 minutes.

In addition, the automotive interior material of the present invention may be dyed. A method for the dyeing is not particularly limited, and may be either a method in which the polycarbonate-based polyurethane resin is attached to the polyester needle-punched nonwoven fabric, followed by dyeing, or a method in which the polyester needle-punched nonwoven fabric is dyed, and then the polycarbonate-based polyurethane resin is attached thereto.

Moreover, in the step of obtaining an automotive interior material, it is possible to also use a cross-linking agent such as an isocyanate-based cross-linking agent, an oxazoline-based cross-linking agent, a carbodiimide-based cross-linking agent, or an epoxy-based cross-linking agent mainly for the purpose of improving the film formability; a film formation aid such as an alkylene glycol derivative, an aliphaticdicarboxylic acid dialkyl ester, or N-methylpyrrolidone; or the like, and it is possible to also use a fluorine-containing leveling agent, an emulsifier such as a dialkyl sulfosuccinate-based emulsifier, any of various leveling agents such as acetylene glycol derivative, a penetrant, or the like mainly for the purpose of improving the processing suitability. Moreover, in the step of obtaining an automotive interior material, it is possible to also use stabilizers such as an antioxidant, an ultraviolet absorber, and an anti-hydrolysis agent mainly for the purpose of improving various durability performances such as light resistance, heat resistance, water resistance, and solvent resistance, it is possible to also use various functional agents such as a fatty acid-based fabric softener, a silicone-based fabric softener, a water repellent, an antistat, a flame retardant, a lubricating agent, a deodorant, and an antibacterial agent, and it is possible to also use a thicker mainly for the purpose of adjusting the viscosity. Moreover, in the step of obtaining an automotive interior material, it is possible to also use various water-soluble or water-dispersible and inorganic or organic pigments mainly for the purpose of coloring, and it is possible to also use fillers such as inorganic fillers including calcium carbonate, talc, aluminium hydroxide, silica, glass fiber, and the like; and organic fillers including cellulose powder, protein powder, silk powder, organic staple fiber, and the like. Moreover, in the step of obtaining an automotive interior material, it is possible to also use polyurethane resins other than the polycarbonate-based polyurethane resin according to the present invention, acrylic resins, epoxy resins, polyester resins, polyamide resins, styrene resins, phenolic resins, vinyl acetate resins, and the like, as long as the effects of the present invention are not impaired. When any of these components is also used, the component may be added to the treatment liquid. Alternatively, the component may be introduced by impregnation into the polyester needle-punched nonwoven fabric after the attachment of the polycarbonate-based polyurethane resin to the polyester needle-punched nonwoven fabric, or the component may be introduced by impregnation into the polyester needle-punched nonwoven fabric before the polycarbonate-based polyurethane resin is attached thereto.

As described above, the method for manufacturing an automotive interior material of the present invention comprises the steps of:

reacting an organic polyisocyanate with a polyol comprising 30 to 99% by mass of a polycarbonate diol represented by the above-described general formula (1), with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals;

dispersing the urethane prepolymer in water by emulsification, followed by chain extension with a polyamine having two or more amino groups of at least one type selected from a primary amino group and a secondary amino group, to obtain a polycarbonate-based polyurethane resin; and

attaching the polycarbonate-based polyurethane resin to a polyester needle-punched nonwoven fabric, to obtain an automotive interior material comprising the polyester needle-punched nonwoven fabric and the polycarbonate-based polyurethane resin attached to the polyester needle-punched nonwoven fabric, wherein

the amount of the polycarbonate-based polyurethane resin attached is 1 to 15 parts by mass relative to 100 parts by mass of the polyester needle-punched nonwoven fabric. The step of obtaining a urethane prepolymer, the step of obtaining a polycarbonate-based polyurethane resin, and the step of obtaining an automotive interior material are each as described above for the automotive interior material of the present invention. This manufacturing method makes it possible to obtain the automotive interior material of the present invention.

### EXAMPLES

Hereinafter, the present invention is described more specifically on the basis of Examples and Comparative Examples; however; the present invention is not limited to Examples below.

<Synthesis of Polyurethane Resins>

### Synthesis Example 1

To a four-necked flask equipped with a stirrer, a reflux condenser, a thermometer, and a nitrogen inlet tube, 281.4 parts by mass of poly-1,6-hexamethylene carbonate diol (number average molecular weight: 3,000) as a polycarbonate diol, 8.3 parts by mass of dimethylolpropionic acid and 1.3 parts by mass of trimethylolpropane as additional polyols, and 150.0 parts by mass of methyl ethyl ketone as an organic solvent were placed, and uniformly mixed. Then, 59.0 parts by mass of dicyclohexylmethane diisocyanate as an organic polyisocyanate and 0.09 parts by mass of bismuth tris(2-ethylhexanoate) as a catalyst were added, and the reaction was allowed to proceed at 80±5° C. for 120 minutes. Thus, a solution of a urethane prepolymer in methyl ethyl ketone was obtained with a free isocyanate group-content in the urethane prepolymer of 1.46% by mass. To this solution, 28.4 parts by mass of 20% triethylamine was added as a neutralizing agent, followed by uniform mixing. Then, 595.4 parts by mass of water was gradually added, followed by stirring for dispersing by emulsification. To this dispersion, 26.2 parts by mass of a 20% aqueous piperazine solution was added as a polyamine (chain extender), followed by stirring at 40±5° C. for 90 minutes. Then, the solvent was removed under reduced pressure at 40° C. Thus, a polyurethane resin composition was obtained which contained 40.0% by mass of a polycarbonate-based water-dispersible polyurethane resin.

Table 1 shows the composition of the components (polycarbonate diol, additional polyols, organic solvent, organic polyisocyanate, catalyst, neutralizing agent, water, and polyamine) blended, as well as the composition of the obtained urethane prepolymer. Note that, in Table 1, the unit of each component blended is “parts by mass;” “Number of carbon atoms of polycarbonate diol” represents the number of carbon atoms of the group corresponding to R¹ in general formula (1); “Polycarbonate diol content” represents the content (blended amount) of the polycarbonate diol relative to the total mass of the polyols; “NCO/OH ratio” represents the mole ratio of NCO groups of the organic polyisocyanate to OH groups of the polyol before the reaction; “Isocyanate content” represents the amount of the organic polyisocyanate blended relative to the total mass of the organic polyisocyanate and the polyols; and “Free isocyanate content” represents the content of free isocyanate groups (NCO groups) in the total mass of the urethane prepolymer (the same shall apply in Table 2 below).

### Synthesis Examples 2 to 5, 7 to 11, and 13 and 14

Each polyurethane resin composition was obtained in the same manner as in Synthesis Example 1, except that the composition of the components (polycarbonate diol, additional polyols, organic solvent, organic polyisocyanate, catalyst, neutralizing agent, water, and polyamine) blended was changed to the corresponding one of the compositions shown in Tables 1 and 2. Tables 1 and 2 show the compositions of components blended and the compositions of the obtained urethane prepolymers.

### Synthesis Example 6

To a four-necked flask equipped with a stirrer, a reflux condenser, a thermometer, and a nitrogen inlet tube, 284.1 parts by mass of poly-1,6-hexamethylene carbonate diol (number average molecular weight: 3,000) as a polycarbonate diol, 6.3 parts by mass of dimethylolpropionic acid as an additional polyol, and 150.0 parts by mass of methyl ethyl ketone as an organic solvent were placed, and uniformly mixed. Then, 59.5 parts by mass of dicyclohexylmethane diisocyanate as an organic polyisocyanate, and 0.09 parts by mass of bismuth tris(2-ethylhexanoate) as a catalyst were added, and the reaction was allowed to proceed at 80±5° C. for 120 minutes. Thus, a solution of a urethane prepolymer in methyl ethyl ketone was obtained with a free isocyanate group-content in the urethane prepolymer of 1.48% by mass. To this solution, 2.0 parts by mass of sodium dihydrogen phosphate as a reaction inhibitor, and 20.0 parts by mass of a polyoxyethylene tristyrylphenyl ether-type nonionic surfactant as an emulsifier were added, and uniformly mixed. Then, 601.5 parts by mass of water was gradually added, followed by stirring for dispersing by emulsification. To this dispersion, 26.5 parts by mass of a 20% aqueous piperazine solution was added as a polyamine (chain extender), followed by stirring at 40±5° C. for 90 minutes. Subsequently, the solvent was removed under reduced pressure at 40° C. Thus, a polyurethane resin composition was obtained which contained 40.0% by mass of a polycarbonate-based water-dispersible polyurethane resin. Table 1 shows the composition of the components (polycarbonate diol, additional polyol, organic solvent, organic polyisocyanate, catalyst, reaction inhibitor, emulsifier, water, and polyamine) blended, as well as the composition of the obtained urethane prepolymer.

### Synthesis Example 12

A polyurethane resin composition was obtained in the same manner as in Synthesis Example 6, except that the composition of the components (polycarbonate diol, additional polyol, organic solvent, organic polyisocyanate, catalyst, reaction inhibitor, emulsifier, water, and polyamine) blended was changed to that shown in Table 2. Table 2 shows the composition of components blended and the composition of the obtained urethane prepolymer.

TABLE 1

| | Synthesis | Synthesis | Synthesis | Synthesis | Synthesis | Synthesis |
|---|---|---|---|---|---|---|
| | Ex. 1 | Ex. 2 | Ex. 3 | Ex. 4 | Ex. 5 | Ex. 6 |
| Poly-1,6- | 281.4 | 112.6 | — | 112.6 | — | 284.1 |
| hexamethylene | | | | | | |
| carbonate diol | | | | | | |
| (MW = 3000) | | | | | | |
| Poly-1,6- | — | — | 256.3 | — | 209.8 | — |
| hexamethylene | | | | | | |
| carbonate diol | | | | | | |
| (MW = 2000) | | | | | | |
| Poly-1,4- | — | 168.9 | — | — | — | — |
| tetramethylene | | | | | | |
| carbonate diol | | | | | | |
| (MW = 3000) | | | | | | |
| Polytetramethylene | — | — | — | 168.9 | — | — |
| glycol (MW = 3000) | | | | | | |
| Dimethylolpropionic | 8.3 | 8.3 | 11.4 | 8.3 | 23.3 | — |
| acid | | | | | | |
| Trimethylolpropane | 1.3 | 1.3 | 1.7 | 1.3 | 7.3 | 6.3 |
| Methyl ethyl ketone | 150 | 150 | 150 | 150 | 150 | 150 |
| Dicyclohexylmethane | 59.0 | 59.0 | 80.6 | 59.0 | 109.9 | 59.5 |
| diisocyanate | | | | | | |
| Bismuth tris | 0.09 | 0.09 | 0.09 | 0.09 | 0.09 | 0.09 |
| (2-ethylhexanoate) | | | | | | |
| 20% triethylamine | 28.4 | 28.4 | 38.8 | 28.4 | 79.5 | — |
| Sodium dihydrogen | — | — | — | — | — | 2 |
| phosphate | | | | | | |
| Polyoxyethylene | — | — | — | — | — | 20 |
| tristyrylphenyl | | | | | | |
| ether-type nonionic | | | | | | |
| surfactant | | | | | | |
| Water | 595.4 | 595.4 | 575.3 | 595.4 | 536.7 | 601.5 |
| 20% piperazine | 26.2 | 26.2 | 35.8 | 26.2 | 33.8 | 26.5 |
| Number of carbon | 6 | 4.6 | 6 | 6 | 6 | 6 |
| atoms of | | | | | | |
| polycarbonate diol | | | | | | |
| Polycarbonate diol | 97 | 97 | 95 | 39 | 87 | 98 |
| content | | | | | | |
| (% by mass) | | | | | | |
| Molecular weight of | 3000 | 3000 | 2000 | 3000 | 2000 | 3000 |
| polycarbonate diol | | | | | | |
| NCO/OH ratio | 1.37/1 | 1.37/1 | 1.37/1 | 1.37/1 | 1.23/1 | 1.37/1 |
| Isocyanate content | 16.9 | 16.9 | 23.0 | 16.9 | 31.4 | 17.0 |
| (% by mass) | | | | | | |
| Free isocyanate | 1.46 | 1.46 | 2.00 | 1.46 | 1.89 | 1.48 |
| content | | | | | | |
| (% by mass) | | | | | | |

TABLE 2

| | Synthesis | Synthesis | Synthesis | Synthesis | Synthesis | Synthesis | Synthesis | Synthesis |
|---|---|---|---|---|---|---|---|---|
| | Ex. 7 | Ex. 8 | Ex. 9 | Ex. 10 | Ex. 11 | Ex. 12 | Ex. 13 | Ex. 14 |
| Poly-1,6- | — | — | — | — | 56.3 | 249.9 | 273.7 | 261.2 |
| hexamethylene | | | | | | | | |
| carbonate diol | | | | | | | | |
| (MW = 3000) | | | | | | | | |
| Polydimethylene | 281.4 | — | — | — | — | — | — | — |
| carbonate diol | | | | | | | | |
| (MW = 3000) | | | | | | | | |
| Poly-1,9- | — | 281.4 | — | — | — | — | — | — |
| nonamethylene | | | | | | | | |
| carbonate diol | | | | | | | | |
| (MW = 3000) | | | | | | | | |
| Poly-1,6- | — | — | 193.1 | — | — | — | — | — |
| hexamethylene | | | | | | | | |
| carbonate diol | | | | | | | | |
| (MW = 900) | | | | | | | | |
| Poly-1,6- | — | — | — | 295.9 | — | — | — | — |
| hexamethylene | | | | | | | | |
| carbonate diol | | | | | | | | |
| (MW = 4000) | | | | | | | | |
| Polytetramethylene | — | — | — | — | 225.1 | 62.5 | — | — |
| glycol (MW = 3000) | | | | | | | | |
| Dimethylolpropionic | 8.3 | 8.3 | 19.1 | 6.6 | 8.3 | 2.6 | 8.1 | 7.7 |
| acid | | | | | | | | |
| Trimethylolpropane | 1.3 | 1.3 | 2.9 | 1.0 | 1.3 | 0.5 | 1.2 | 1.2 |
| Methyl ethyl ketone | 150 | 150 | 150 | 150 | 150 | 150 | 150 | 150 |
| Dicyclohexylmethane | 59.0 | 59.0 | 134.9 | 46.5 | 59.0 | 34.6 | 66.9 | 79.9 |
| diisocyanate | | | | | | | | |
| Bismuth tris | 0.09 | 0.09 | 0.09 | 0.09 | 0.09 | 0.09 | 0.09 | 0.09 |
| (2-ethylhexanoate) | | | | | | | | |
| 20% triethylamine | 28.4 | 28.4 | 65.0 | 22.4 | 28.4 | 8.8 | 27.6 | 26.4 |
| Polyoxyethylene | — | — | — | — | — | 10 | — | — |
| tristyrylphenyl | | | | | | | | |
| ether-type nonionic | | | | | | | | |
| surfactant | | | | | | | | |
| Water | 595.4 | 595.4 | 525.0 | 606.9 | 595.4 | 629.0 | 581.2 | 558.1 |
| 20% piperazine | 26.2 | 26.2 | 60.0 | 20.7 | 26.2 | 2.2 | 41.2 | 65.5 |
| Number of carbon | 2 | 9 | 6 | 6 | 6 | 6 | 6 | 6 |
| atoms of | | | | | | | | |
| polycarbonate diol | | | | | | | | |
| Polycarbonate diol | 97 | 97 | 90 | 98 | 19 | 79 | 97 | 97 |
| content (% by mass) | | | | | | | | |
| Molecular weight of | 3000 | 3000 | 900 | 4000 | 3000 | 3000 | 3000 | 3000 |
| polycarbonate diol | | | | | | | | |
| NCO/OH ratio | 1.37/1 | 1.37/1 | 1.37/1 | 1.37/1 | 1.37/1 | 1.04/1 | 1.60/1 | 2.00/1 |
| Isocyanate content | 16.9 | 16.9 | 38.6 | 13.3 | 16.9 | 9.87 | 19.1 | 22.8 |
| (% by mass) | | | | | | | | |
| Free isocyanate | 1.46 | 1.46 | 3.35 | 1.15 | 1.46 | 0.12 | 2.30 | 3.66 |
| content (% by mass) | | | | | | | | |

<Manufacturing of Automotive Interior Material>

### Example 1-1

To 5 parts by mass of the polyurethane resin composition obtained in Synthesis Example 1, 95 parts by mass of water was added to prepare a treatment liquid containing 2% by mass of the polycarbonate-based water-dispersible polyurethane resin. In this treatment liquid, a polyester needle-punched nonwoven fabric (mass per unit area: 300 g/m²) was immersed, and squeezed with a mangle to achieve a pick-up of 150% by mass (the amount of the resin attached was 3 parts by mass (3% by mass) relative to 100 parts by mass of the nonwoven fabric), followed by drying with a pin tenter at 120° C. for 5 minutes. Thus, an automotive interior material was obtained.

### Examples 1-2 to 1-6 and Comparative Examples 1-1 to 1-8

Each automotive interior material was obtained in the same manner as in Example 1-1, except that the corresponding one of the resin compositions shown in Table 3 and Table 4 was used instead of the polyurethane resin composition obtained in Synthesis Example 1.

### Example 2-1 and Comparative Examples 2-1 and 2-2

Each automotive interior material was obtained in the same manner as in Example 1-1, except that the amount of the resin attached to the nonwoven fabric was changed to the corresponding one of the conditions shown in Table 5.

### Comparative Example 2-3

An automotive interior material (floor carpet material) was obtained in the same manner as in Example 1-1, except that water was used instead of the polyurethane resin composition obtained in Synthesis Example 1.

### Comparative Example 2-4

An automotive interior material was obtained in the same manner as in Example 1-1, except that a treatment liquid having an acrylic resin content of 8% by mass obtained as follows was used. Specifically, the treatment liquid was obtained by mixing 16 parts by mass of an acrylic resin emulsion (50% by mass aqueous solution), which had been obtained by copolymerization of 50 parts by mass of butyl acrylate and 50 parts by mass of 2-ethylhexyl acrylate in water solvent, with 84 parts by mass of water.

### Comparative Example 2-5

A vehicle door trim surface material (polyester jersey (knitted fabric made of polyester filament), mass per unit area: 300 g/m²), as it was, was used as an automotive interior material.

<Evaluation of Automotive Interior Materials>

The obtained automotive interior materials were measured for elongation (processability), average coefficient of surface friction (MIU), wear resistance (Magic Tape resistance, and Taber abrasion), and the attaching state of urethane resin by the following methods. Tables 3 to 5 show the results.

(Elongation)

The elongation was measured by the same method as the method A of JIS L 1096 8.14.1. The formability can be considered to be good, when the elongation is 80% or higher.

(Average Coefficient of Surface Friction (MIU))

The obtained automotive interior materials were cut into 200 mm×200 mm test pieces. Each test piece was measured for the average coefficient of surface friction (MIU) by using a KES-FB4 automated surface tester (manufactured by KATO TECH CO., LTD.) according to the manual of the tester. The texture can be considered to be good, when the MIU is 0.35 or lower.

(Wear Resistance (Magic Tape Resistance))

The obtained automotive interior materials were cut into test pieces of 70 mm in width×300 mm in length. Each test piece was placed on a plane abrasion tester (manufactured by Suga Test Instruments Co., Ltd., FR-P model), and a friction test was conducted by 15-time reciprocation under a force of 9.8 N, with Magic Tape (registered trademark, a standard nylon product manufactured by KURARAY CO., LTD.) attached to the friction block. Then, the Magic Tape resistance was evaluated according to the following criteria:

5: Unchanged from the state before the test,

4: Slightly fuzzy,

3: Somewhat fuzzy, but drawing-out of a yarn(s), yarn break, laddering, or the like was absent, or, if any, drawing-out of a yarn (s), yarn break, or laddering was not remarkable,

2: Remarkably fuzzy, and a yarn(s) was drawn out, and

1: Remarkably fuzzy, and a yarn(s) drawn out was considerably damaged and intense laddering was present, or a yarn(s) was broken.

(Wear Resistance (Taber Abrasion))

The wear Resistance was measured by the same method as in JIS L 1096 8.19.5E, except that the number of times of abrasion was changed to 500 times. After the test, the worn portion of the test piece was observed, and the wear resistance of the worn portion was evaluated according to the following criteria:

5: The state did not change from that before the test, and any abnormality was observed at all,

4: Abnormality was slightly observed,

3: Abnormality was apparently observed,

2: Abnormality was somewhat remarkably observed, and

1: Abnormality was remarkably observed.

(Attaching State of Urethane Resin)

The obtained automotive interior materials were evaluated as follows. Specifically, a cross section of each automotive interior material was observed at 150 times magnification by using a scanning electron microscope (JSM-6010 LA (manufactured by JEOL Ltd.)), and a comparison was made between the adhering state of the resin present at a central portion and the adhering state of the resin present at a surface portion of the polyester needle-punched nonwoven fabric, and evaluation was made according to the following criteria:

5: Any difference in the amount of the adhering resin was observed at all between the central portion and the surface portion,

4: Little difference in the amount of the adhering resin was observed between the central portion and the surface portion,

3: Slight difference in the amount of the adhering resin was observed between the central portion and the surface portion, and no resin adhered to a portion of the central portion which accounted for 10% of the total thickness,

2: Considerable difference in the amount of the adhering resin was observed between the central portion and the surface portion, and no resin adhered to a portion of the central portion which accounted for 30% of the total thickness,

1: Remarkable difference in the amount of the adhering resin was observed between the central portion and the surface portion, and no resin adhered to a portion of the central portion which accounted for 50% of the total thickness.

Note that when the adhering state of the resin was between two of the criteria, for example, when the adhering state was between 4 and 5, the adhering state was evaluated as “4-5.”

TABLE 3

| | Ex. | Ex. | Ex. | Ex. | Ex. | Ex. |
|---|---|---|---|---|---|---|
| | 1-1 | 1-2 | 1-3 | 1-4 | 1-5 | 1-6 |
| Resin composition | Synthesis | Synthesis | Synthesis | Synthesis | Synthesis | Synthesis |
| | Ex. 1 | Ex. 2 | Ex. 3 | Ex. 4 | Ex. 5 | Ex. 6 |
| Elongation (%) | 90 | 90 | 90 | 80 | 80 | 85 |
| Average coefficient | 0.3 | 0.31 | 0.3 | 0.3 | 0.3 | 0.3 |
| of surface friction | | | | | | |
| (MIU) | | | | | | |
| Magic Tape | 3 | 3 | 3 | 3 | 3 | 3 |
| resistance (grade) | | | | | | |
| Taber abrasion | 3 | 3 | 3 | 3 | 3 | 3 |
| (grade) | | | | | | |
| Attaching state of | 5 | 5 | 5 | 5 | 5 | 5 |
| urethane resin | | | | | | |

TABLE 4

| | Comp. | Comp. | Comp. | Comp. | Comp. | Comp. | Comp. | Comp. |
|---|---|---|---|---|---|---|---|---|
| | Ex. | Ex. | Ex. | Ex. | Ex. | Ex. | Ex. | Ex. |
| | 1-1 | 1-2 | 1-3 | 1-4 | 1-5 | 1-6 | 1-7 | 1-8 |
| Resin | Synthesis | Synthesis | Synthesis | Synthesis | Synthesis | Synthesis | Synthesis | Synthesis |
| composition | Ex. 7 | Ex. 8 | Ex. 9 | Ex. 10 | Ex. 11 | Ex. 12 | Ex. 13 | Ex. 14 |
| Elongation (%) | 70 | 90 | 70 | 80 | 90 | 90 | 70 | 70 |
| Average | 0.35 | 0.3 | 0.36 | 0.35 | 0.37 | 0.31 | 0.36 | 0.35 |
| coefficient of | | | | | | | | |
| surface | | | | | | | | |
| friction (MIU) | | | | | | | | |
| Magic Tape | 3 | 2 | 3 | 2 | 1 | 1 | 2 | 3 |
| resistance | | | | | | | | |
| (grade) | | | | | | | | |
| Taber abrasion | 3 | 2 | 3 | 2 | 1 | 1 | 2 | 3 |
| (grade) | | | whitening | | | | | whitening |
| Attaching state | 5 | 5 | 5 | 5 | 5 | 5 | 5 | 5 |
| of urethane | | | | | | | | |
| resin | | | | | | | | |

TABLE 5

| | | | Comp. | Comp. | Comp. | Comp. | Comp. |
|---|---|---|---|---|---|---|---|
| | Ex. | Ex. | Ex. | Ex. | Ex. | Ex. | Ex. |
| | 1-1 | 2-1 | 2-1 | 2-2 | 2-3 | 2-4 | 2-5 |
| Resin | Synthesis | Synthesis | Synthesis | Synthesis | None | *1 | — |
| composition | Ex. 1 | Ex. 1 | Ex. 1 | Ex. 1 | | | |
| Amount of resin | 3 | 12 | 0.6 | 18 | 0 | 12 | — |
| attached | | | | | | | |
| (relative to | | | | | | | |
| nonwoven | | | | | | | |
| fabric) (%) | | | | | | | |
| Drying temp. | 120 | 150 | 120 | 120 | 120 | 120 | — |
| (° C.) | | | | | | | |
| Elongation (%) | 90 | 85 | 90 | 80 | 70 | 90 | 90 |
| Average | 0.3 | 0.3 | 0.35 | 0.35 | 0.4 | 0.4 | 0.35 |
| coefficient of | | | | | | | |
| surface | | | | | | | |
| friction (MIU) | | | | | | | |
| Magic Tape | 3 | 3 | 1 | 3 | 1 | 1 | 3 |
| resistance | | | | | | | |
| (grade) | | | | | | | |
| Taber abrasion | 3 | 3 | 2 | 2 | 2 | 1 | 3 |
| (grade) | | | | whitening | | | |
| Attaching state | 5 | 5 | 5 | 5 | 5 | 5 | — |
| of urethane | | | | | | | |
| resin | | | | | | | |

*1 Copolymer of butyl acrylate and 2-ethylhexyl acrylate (at a mass ratio of 1:1)

It was found that the automotive interior materials of the present invention had excellent wear resistance without impairment of the texture and good processability of polyester needle-punched nonwoven fabric, and that the automotive interior materials of the present invention had better performances than those in the case where the aqueous acrylic resin emulsion was used (Comparative Example 2-4) and than those of the floor carpet (Comparative Example 2-3), and had performances comparable to those of the knitted fabric made of polyester filament (Comparative Example 2-5).

### INDUSTRIAL APPLICABILITY

As described above, according to the present invention, it is possible to provide an automotive interior material which has an excellent wear resistance, while retaining the texture and good processability of needle-punched nonwoven fabric, as well as a method for manufacturing the same.

What is claimed is:

1. An automotive interior material, comprising: a polyester needle-punched nonwoven fabric; and a polycarbonate-based polyurethane resin attached to the polyester needle-punched nonwoven fabric, wherein
the polycarbonate-based polyurethane resin is obtained by reacting an organic polyisocyanate with a polyol comprising 30 to 99% by mass of a polycarbonate diol represented by the following general formula (1): 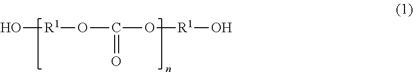
wherein R¹s each independently represent an alkylene group having 4 to 8 carbon atoms, and n represents an integer with which a molecular weight of the compound represented by the formula (1) is in a range from 1000 to 3500,
with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals, and dispersing the urethane prepolymer in water by emulsification, followed by chain extension with a polyamine having two or more amino groups of at least one type selected from a primary amino group and a secondary amino group, and
the amount of the polycarbonate-based polyurethane resin attached is 1 to 15 parts by mass relative to 100 parts by mass of the polyester needle-punched nonwoven fabric.

2. The automotive interior material according to claim 1, wherein n of formula (1) represents an integer with which the molecular weight of the compound represented by the formula (1) is in a range from 1500 to 3300.

3. The automotive interior material according to claim 1, wherein the polyol comprises 50 to 95% by mass of the polycarbonate diol.

4. The automotive interior material according to claim 2, wherein the polyol comprises 50 to 95% by mass of the polycarbonate diol.

5. The automotive interior material according to claim 1, wherein the amount of the polycarbonate-based polyurethane resin attached is 3 to 12 parts by mass relative to 100 parts by mass of the polyester needle-punched nonwoven fabric.

6. The automotive interior material according to claim 2, wherein the amount of the polycarbonate-based polyurethane resin attached is 3 to 12 parts by mass relative to 100 parts by mass of the polyester needle-punched nonwoven fabric.

7. The automotive interior material according to claim 3, wherein the amount of the polycarbonate-based polyurethane resin attached is 3 to 12 parts by mass relative to 100 parts by mass of the polyester needle-punched nonwoven fabric.

8. The automotive interior material according to claim 4, wherein the amount of the polycarbonate-based polyurethane resin attached is 3 to 12 parts by mass relative to 100 parts by mass of the polyester needle-punched nonwoven fabric.

9. A method for manufacturing an automotive interior material, comprising the steps of:
reacting an organic polyisocyanate with a polyol comprising 30 to 99% by mass of a polycarbonate diol represented by the following general formula (1): 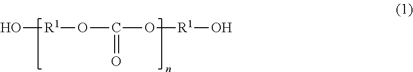
wherein R¹s each independently represent an alkylene group having 4 to 8 carbon atoms, and n represents an integer with which a molecular weight of the compound represented by the formula (1) is in a range from 1000 to 3500,
with a mole ratio between NCO groups of the organic polyisocyanate and OH groups of the polyol (the number of moles of NCO groups/the number of moles of OH groups) being 1.5/1.0 to 1.1/1.0, to obtain a urethane prepolymer having isocyanate groups at terminals;
dispersing the urethane prepolymer in water by emulsification, followed by chain extension with a polyamine having two or more amino groups of at least one type selected from a primary amino group and a secondary amino group, to obtain a polycarbonate-based polyurethane resin; and
attaching the polycarbonate-based polyurethane resin to a polyester needle-punched nonwoven fabric, to obtain an automotive interior material comprising the polyester needle-punched nonwoven fabric and the polycarbonate-based polyurethane resin attached to the polyester needle-punched nonwoven fabric, wherein
the amount of the polycarbonate-based polyurethane resin attached is 1 to 15 parts by mass relative to 100 parts by mass of the polyester needle-punched nonwoven fabric.

10. The method for manufacturing an automotive interior material according to claim 9, wherein n of formula (1) represents an integer with which the molecular weight of the compound represented by the formula (1) is in a range from 1500 to 3300.

11. The method for manufacturing an automotive interior material according to claim 9, wherein the polyol comprises 50 to 95% by mass of the polycarbonate diol.

12. The method for manufacturing an automotive interior material according to claim 10, wherein the polyol comprises 50 to 95% by mass of the polycarbonate diol.

13. The method for manufacturing an automotive interior material according to claim 9, wherein the amount of the polycarbonate-based polyurethane resin attached is 3 to 12 parts by mass relative to 100 parts by mass of the polyester needle-punched nonwoven fabric.

14. The method for manufacturing an automotive interior material according to claim 10, wherein the amount of the polycarbonate-based polyurethane resin attached is 3 to 12 parts by mass relative to 100 parts by mass of the polyester needle-punched nonwoven fabric.

15. The method for manufacturing an automotive interior material according to claim 11, wherein the amount of the polycarbonate-based polyurethane resin attached is 3 to 12 parts by mass relative to 100 parts by mass of the polyester needle-punched nonwoven fabric.

16. The method for manufacturing an automotive interior material according to claim 12, wherein the amount of the polycarbonate-based polyurethane resin attached is 3 to 12 parts by mass relative to 100 parts by mass of the polyester needle-punched nonwoven fabric.
